(19) United States
(12) Patent Application Publication
(10) Pub. No.: US 2010/0034298 A1
(43) Pub. Date: Feb. 11, 2010

(54) RAIL VEHICLE INTERNAL INFORMATION NETWORK DEVICE

(75) Inventors: Atsushi TAKAHASHI, Tokyo (JP); Yasuyuki MIYAJIMA, Tokyo (JP); Shinsuke WATANABE, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/535,325

(22) Filed: Aug. 4, 2009

(30) Foreign Application Priority Data
Aug. 5, 2008 (JP) 2008-201773

(51) Int. Cl. H04B 15/00; H04B 3/00

(52) U.S. Cl. 375/257

(57) ABSTRACT

A rail vehicle internal information network device has modulating transmission devices (11) that transmit modulated signals in accordance with the characteristics of the transmission wire and that demodulate received signals, and a transmission wire (12) that transmits signals and connects the modulating transmission devices (11), wherein the modulating transmission devices (11) have transmission output adjustment means (20) constituted by means for preventing lowering of transmission performance by avoiding the effect of external noise or the effect of signal interference. In this way, a high-speed information network in a rail vehicle can be constructed without employing coaxial cable or shielded wire as transmission wires for high-frequency communication.

### CROSS-REFERENCE TO RELATED APPLICATION

This application claims benefit of priority from Japanese Application No. JP 2008-201773, filed Aug. 5, 2008, the entire contents of which are incorporated by reference herein.

### BACKGROUND OF THE INVENTION

1. Field of the Invention

The present invention relates to a rail vehicle internal information network device that transmits a signal that is modulated in accordance with the characteristics of a transmission line, and that employs a modulating transmission device that performs demodulation of a received signal.

2. Description of the Related Art

For exchange of data between control devices and/or display devices within rail vehicles, network transmission is employed. When high-speed communication is to be performed using baseband transmission within a rail vehicle, transmission wires for high-frequency communication, such as for example coaxial cable or shielded twisted wires, must be employed. In contrast, high-speed communication can be performed using for example ordinary single-core shielded wire, multi-core shielded wire, or shielded twisted wire or single wires, without using high-frequency communication transmission wires, by performing communication in which for example a modulating transmission device employing a frequency division multiplexing system is used to convert the signal to an electrical signal in accordance with the characteristics of the transmission medium.

Systems have been disclosed in which stability of communication is improved, even on lead wires constituting signal wires for a train; these systems are constructed so as to achieve transmission, by modulation of communication frames, between a relay device that is connected in an in-vehicle network in which terminals are connected, and a relay device in another, adjacent vehicle, and are little affected by signal attenuation or noise. An example of such a system is disclosed in Laid-open Japanese Patent Application No. 2008-113103 (hereinbelow referred to as Patent Reference 1).

Also, as a rail vehicle transmission device, a CSMA/CD (Carrier Sense Multiple Access/Collision Detection) system may be adopted, using two pairs of twisted pair cables within the home vehicle but, between vehicles, using a single pair of twisted pair cables to construct a network. An example of such a system is disclosed in Laid-open Japanese Patent Application No. 2005-80253 (hereinbelow referred to as Patent Reference 2).

However, transmission wires within a rail vehicle are frequently arranged in close proximity with wires for other applications and noise-generating equipment and are therefore often affected by noise. As shown in FIG. 1, when modulating transmission devices 11a, 11b are connected by a transmission wire 12, if there is wiring 13 adjacent to this transmission wire 12, the transmission wire 12 may be affected by noise from this adjacent wiring 13. Also, as shown in FIG. 2, if noise-generating equipment 14 is arranged adjacent to the transmission wire 12, the transmission wire 12 may be affected by noise from this noise-generating equipment 14. Furthermore, if, as shown in FIG. 3, transmission wires 12 are arranged adjacent to each other, signal interference may take place between the transmission wires 12, causing generation of transmission errors or a lowering of the transmission rate etc.

### SUMMARY OF THE INVENTION

The present invention was made in order to overcome the above problems, an object of the present invention being to provide a rail vehicle internal information network device whereby the effect of signal interference or the effect of external noise can be avoided.

In order to achieve the above object, a rail vehicle internal information network device according to the present invention is constructed as follows. Specifically,

a rail vehicle internal information network device comprises modulating transmission devices that transmit modulated signals in accordance with the characteristics of the transmission wire and that demodulate received signals, and a transmission wire that transmits signals and is connected between said modulating transmission devices, characterized in that said modulating transmission device comprises a preventing lowering of transmission characteristic means (or means for preventing lowering of transmission performance) by avoiding the effect of external noise or the effect of signal interference.

With the present invention, a rail vehicle internal information network device can be provided in which the effect of external noise or the effect of signal interference can be avoided.

### BRIEF DESCRIPTION OF THE DRAWINGS

FIG. 1 is a diagram of the case where another wiring is present adjacent to the transmission wire that effects connection between modulating transmission devices of a rail vehicle internal information network, with the result that the transmission wire is affected by noise.

FIG. 2 is a diagram of the case where noise-generating equipment is present adjacent to the transmission wire that effects connection between modulating transmission devices of a rail vehicle internal information network, with the result that the transmission wire is affected by noise.

FIG. 3 is a diagram of the case where transmission wires that effect connection between modulating transmission devices of a rail vehicle internal information network are adjacently arranged, causing signal interference between the transmission wires.

FIG. 4 is a layout diagram showing an example of a mode of connection of modulating transmission devices of a rail vehicle internal information network according to an embodiment of the present invention.

FIG. 5 is a layout diagram showing another example of a mode of connection of modulating transmission devices of a rail vehicle internal information network according to an embodiment of the present invention.

FIG. 6 is a layout diagram showing yet another example of a mode of connection of modulating transmission devices of a rail vehicle internal information network according to an embodiment of the present invention.

FIG. 7 is an internal layout diagram of a modulating transmission device in the case of the multidrop connection system of FIG. 4.

FIG. 8 is an internal layout diagram of a modulating transmission device in the case of the repeater connection system of FIG. 5.

FIG. 9 is an internal layout diagram of a modulating transmission device of the connection system of FIG. 6.

FIG. 10 is a layout diagram showing an example of a modulating transmission device according to a first embodiment of the present invention.

FIG. 11 is a layout diagram showing an example of a mode of connection of modulating transmission devices of a rail vehicle internal information network in the case where the transmission output is automatically adjusted by means of an instruction from a display controller arranged in a driver's console of the first embodiment of the present invention.

FIG. 12 is a layout diagram showing an example of a mode of connection of modulating transmission devices of a rail vehicle internal information network in the case where the transmission output is automatically adjusted by means of an instruction from a maintenance terminal in the first embodiment of the present invention.

FIG. 13 is a layout diagram showing another example of a modulating/demodulating circuit of a modulating transmission device in the first embodiment of the present invention.

FIG. 14 is a layout diagram showing an example of a modulating/demodulating circuit of a modulating transmission device in a second embodiment of the present invention.

FIG. 15 is a layout diagram showing another example of a modulating/demodulating circuit of a modulating transmission device in the second embodiment of the present invention.

FIG. 16 is a layout diagram showing an example of a modulating transmission device in a third embodiment of the present invention.

FIG. 17 is a layout diagram showing another example of modulating/demodulating circuit of a modulating transmission device in the third embodiment of the present invention.

FIG. 18 is a diagram of an example of frequency division in a modulating/demodulating transmission device in the third embodiment of the present invention.

FIG. 19 is a layout diagram of a rail vehicle internal information network in the case where different frequencies are employed in each zone of the transmission wires in the third embodiment of the present invention.

FIG. 20 is a diagram of another example of frequency division in a modulating transmission device in the third embodiment of the present invention.

FIG. 21 is a layout diagram showing an example of a modulating/demodulating circuit of a modulating transmission device in a fourth embodiment of the present invention.

FIG. 22 is a diagram of another example of frequency division in a modulating transmission device in the third embodiment of the present invention.

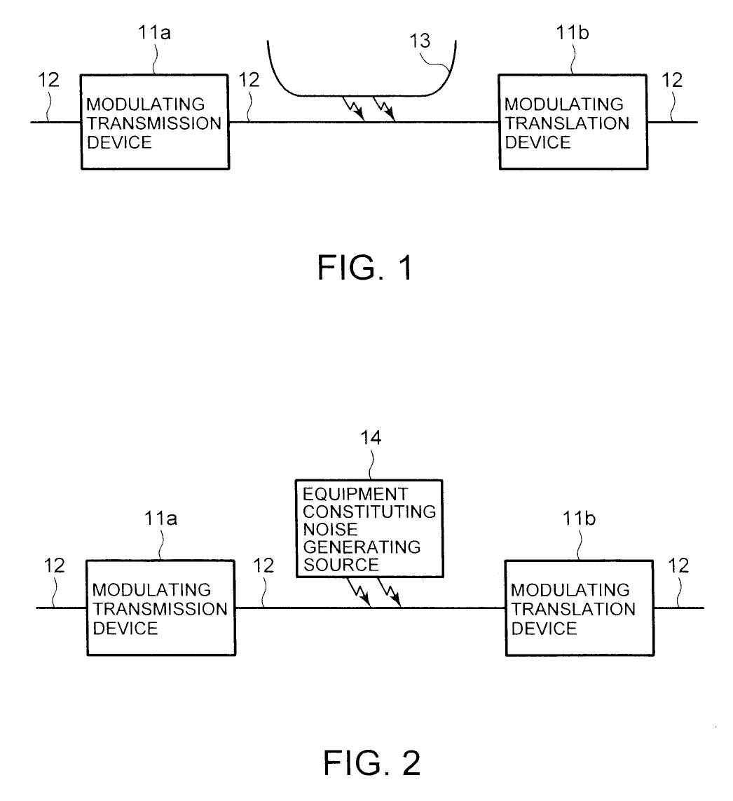

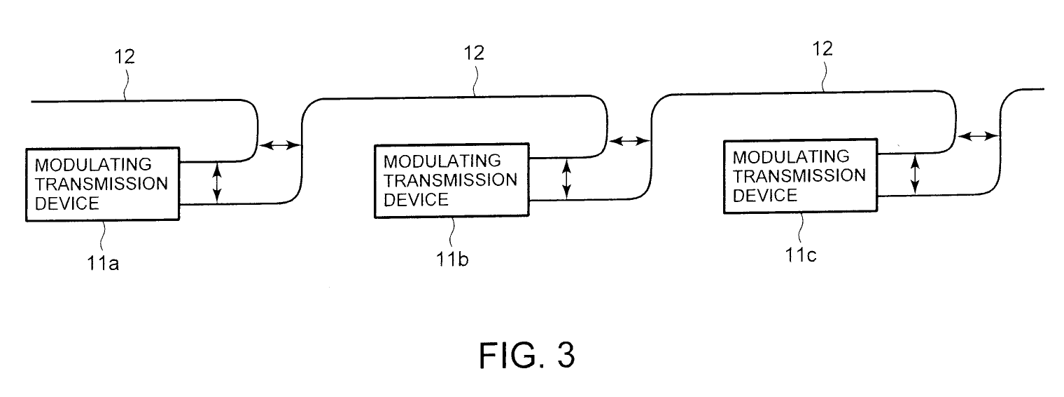

### DETAILED DESCRIPTION OF THE PREFERRED EMBODIMENTS

Embodiments of the present invention are described below with reference to the drawings.

### First Embodiment

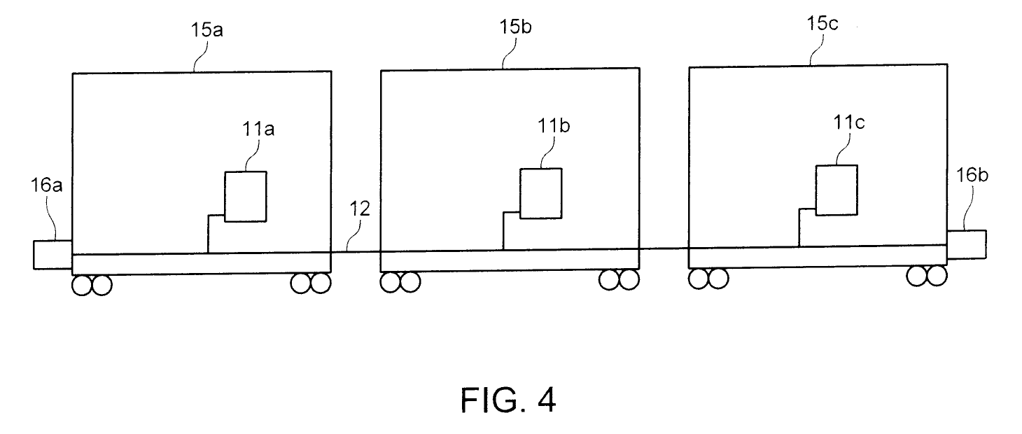

First of all, modes of connection of modulating transmission devices of a rail vehicle internal information network according to an embodiment of the present invention will be described. As the connection mode of the modulating transmission device to the transmission wire, the multidrop connection system or repeater connection system may be employed. FIG. 4 is a layout diagram showing an example of the mode of connection of the modulating transmission devices of a rail vehicle internal information network according to an embodiment of the present invention: the case of a multidrop connection system is shown. The modulating transmission devices 11a to 11c are mounted on rail vehicles 15a to 15c and are connected in multidrop fashion with the transmission wires 12 between the rail vehicles 15a to 15c, in order to perform exchange of data. The transmission wires 12 of the lead vehicle 15a and rearmost vehicle 15c are connected with electrical connectors 16a, 16b.

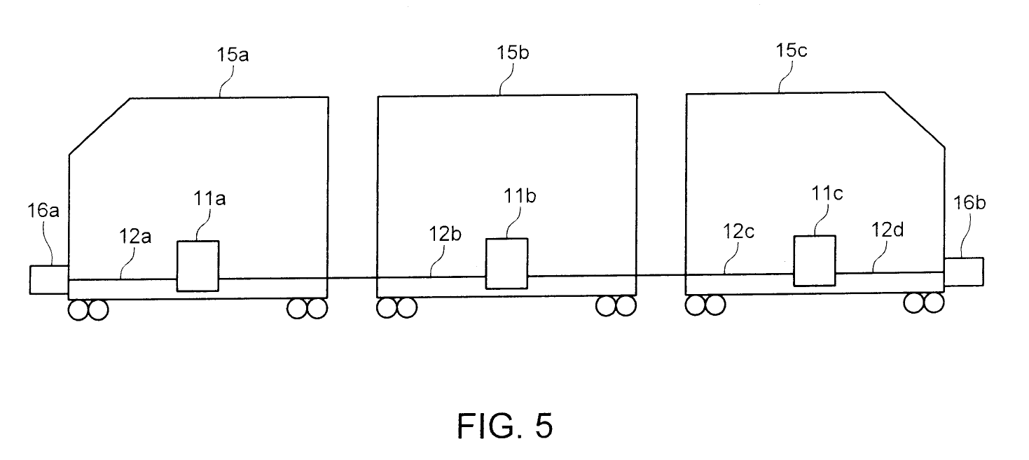

FIG. 5 is a layout diagram showing another example of a mode of connection of modulating transmission devices of a rail vehicle internal information network according to an embodiment of the present invention, showing the case of a repeater connection system. The modulating transmission devices 11a to 11c are mounted on rail vehicles 15a to 15c and are connected by transmission wires 12a to 12d in order to perform exchange of data. The transmission wire 12a of the lead vehicle 15a is connected with an electrical connector 16a and the transmission wire 12d of the rearmost vehicle 15c is connected with an electrical connector 16b.

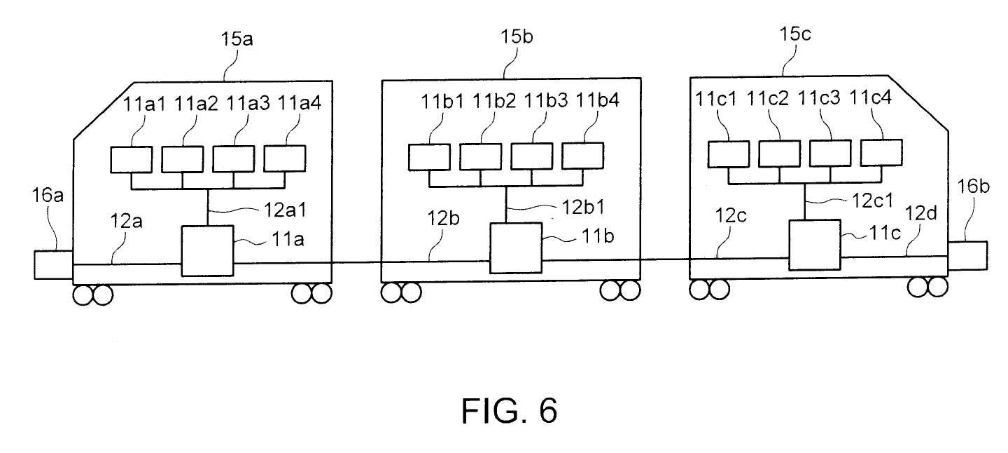

FIG. 6 is a layout diagram showing yet another example of a mode of connection of modulating transmission devices of a rail vehicle internal information network according to an embodiment of the present invention. Regarding the repeater connection of FIG. 5, a multidrop connection is performed using modulating transmission devices 11a1 to 11c4, even within the rail vehicles 15a to 15c.

The modulating transmission device 11a and modulating transmission devices 11a1 to 11a4 of the rail vehicle 15a perform exchange of data by multidrop connection by the transmission wire 12a1 within the rail vehicle 15a. Likewise, exchange of data is performed by multidrop connection of the modulating transmission device 11b and the modulating transmission devices 11b1 to 11b4 of the rail vehicle 15b with the transmission wire 12b1 and exchange of data is performed by multidrop connection of the modulating transmission device 11c and the modulating transmission devices 11c1 to 11c4 of the rail vehicle 15c with the transmission wire 12c1.

In FIG. 6, repeater connection was adopted between the rail vehicles 15a to 15c and multidrop connection was adopted for the in-vehicle wiring; however, as a combination of the connection between the rail vehicles 15a to 15c and the connection within the rail vehicles 15a to 15c, it would alternatively be possible to employ multidrop connection between the rail vehicles 15a to 15c and to employ repeater connection for the in-vehicle wiring. And multidrop connection could be adopted both between the rail vehicles 15a to 15c and for the in-vehicle wiring, or repeater connection could be adopted both between the rail vehicles 15a to 15c and for the in-vehicle wiring.

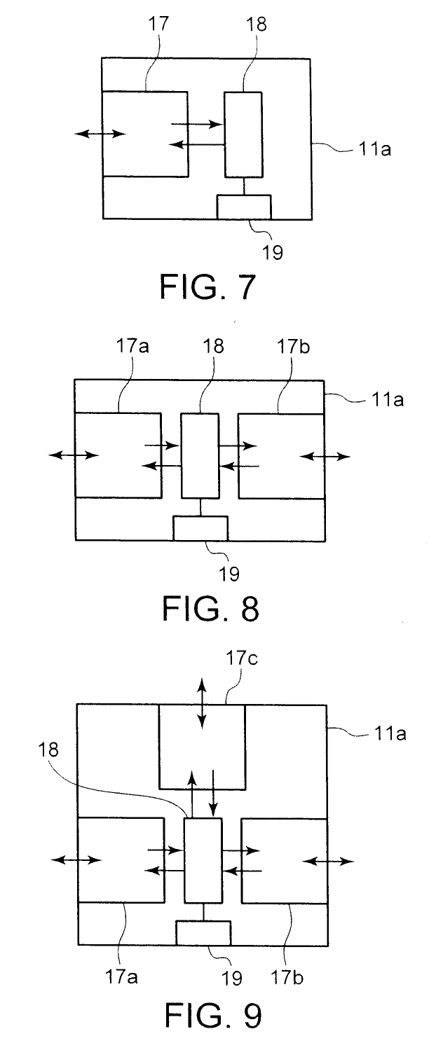

FIG. 7 is an internal layout diagram of a modulating transmission device 11a in the case of the multidrop connection system of FIG. 4. As shown in FIG. 7, a modulating/demodulating circuit 17 is incorporated in the modulating transmission device 11a and exchange of signals on the transmission wire 12 is performed by the modulating/demodulating circuit 17. The modulating/demodulating circuit 17 is connected with a relay processing unit 18 and the relay processing unit 18 performs transmission through an input/output unit 19 or is connected by digital input/output or analogue input/output with equipment etc. within the rail vehicle 15a.

FIG. 8 is an internal layout diagram of a modulating transmission device 11a in the case of the repeater connection system of FIG. 5. As shown in FIG. 8, modulating/demodulating circuits 17a, 17b are incorporated in the modulating transmission device 11a and exchange of signals with the transmission wires 12a, 12b is performed by the modulating/demodulating circuits 17a, 17b. The modulating/demodulating circuits 17a, 17b are connected with a relay processing unit 18; the relay processing unit 18 performs transmission through an input/output unit 19 or is connected by digital input/output or analogue input/output with equipment etc. within the rail vehicle 15.

FIG. 9 is an internal layout diagram of a modulating transmission device 11a in the case of the connection system of FIG. 6. As shown in FIG. 9, modulating/demodulating circuits 17a, 17b, 17c are incorporated in the modulating transmission device 11a and exchange of signals with the transmission wires 12a, 12b, 12a1 is performed by the modulating/demodulating circuits 17a, 17b, and 17c. The modulating/demodulating circuits 17a, 17b, 17c are connected with a relay processing unit 18; the relay processing unit 18 is connected through an input/output unit 19 with equipment etc. within the rail vehicle 15.

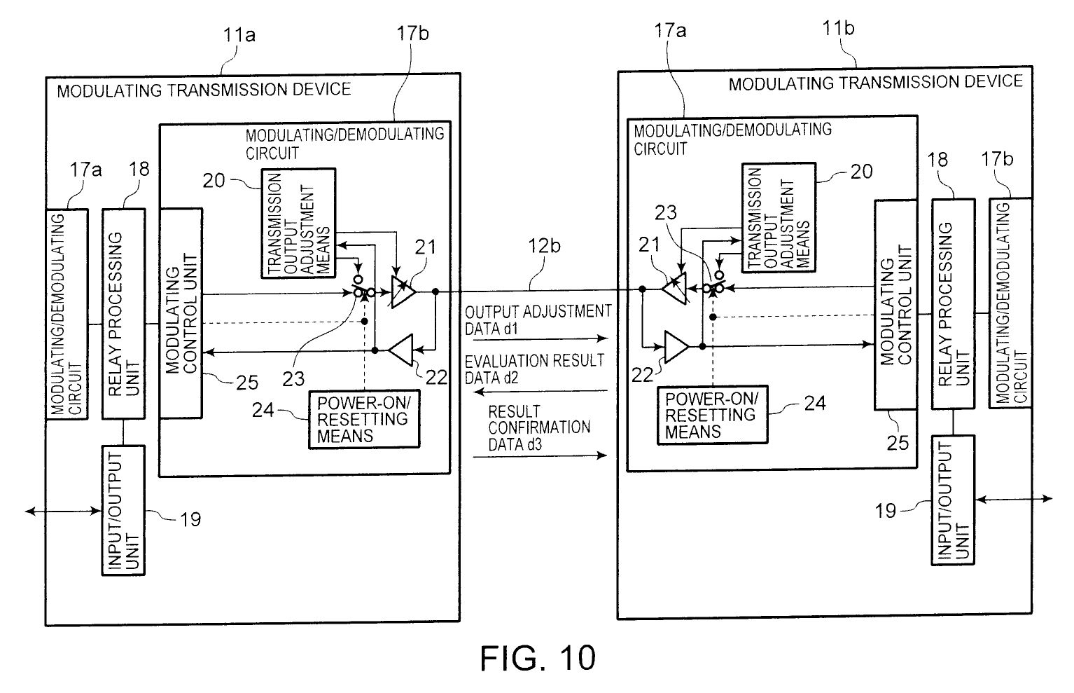

Next, a modulating transmission device of a rail vehicle internal information network according to an embodiment of the present invention will be described. FIG. 10 is a layout diagram showing an example of a modulating transmission device 11a according to a first embodiment of the present invention. In this first embodiment, the modulating transmission devices 11a, 11b in the case of the repeater connection system shown in FIG. 8 are shown. Also, the case is shown in which a preventing lowering of transmission characteristic means is constituted by transmission output adjustment means 20. The modulating transmission devices 11a, 11b are connected through the transmission wire 12b so that they can mutually exchange signals. The case of signal transmission from the modulating transmission device 11a to the modulating transmission device 11b will now be described. The modulating transmission devices 11a, 11b are of the same construction, so only the modulating transmission device 11a will be described.

The modulating transmission device 11a comprises modulating/demodulating circuits 17a, 17b, a relay processing unit 18 and an input/output unit 19. The modulating/demodulating circuits 17 comprise transmission output adjustment means 20, a transmission circuit unit 21, a reception circuit unit 22, changeover means 23, power-on/reset means 24 and a modulation control unit 25.

In normal system operation, the modulation control unit 25 connects the modulation control unit 25 and the transmission circuit unit 21 by the changeover means 23 and transmits signals from the modulation control unit 25 to the modulating transmission device 11b on the transmission wire 12b and signals from the modulating transmission device 11b are received by the reception circuit unit 22 and input to the modulation control unit 25. During such normal system operation, the modulation control unit 25 for example performs an action whereby the changeover means 23 is changed over to the transmission output adjustment means 20 with a certain timing, or periodically, so that the transmission output is automatically adjusted by the transmission output adjustment means 20.

When the transmission output adjustment means 20 of the modulating/demodulating circuit 17b is changed over by the changeover means 23, it transmits output adjustment data d1 in respect of the modulating/demodulating circuit 11a in the modulating transmission device 11b. When the modulating/demodulating circuit 17a of the modulating transmission device 11b receives the output adjustment data d1 it for example ascertains the signal to noise ratio (S/N ratio) and transmits the data d2 of the result of this evaluation to the modulating/demodulating circuit 17b in the modulating transmission device 11a. The modulating/demodulating circuit 17b in the modulating transmission device 11a receives the data d2 of the result of the evaluation by the transmission output adjustment means 20.

After receiving the evaluation result data d2, the transmission output adjustment means 20 transmits data d3 representing confirmation of the result to the modulating/demodulating circuit 17a in the modulating transmission device 11 and thereby achieves automatic adjustment of the transmission output in accordance with the evaluation result data d2. In fact, transmission of data d3 representing confirmation of the result could be dispensed with. For example, it could be arranged for the transmission output to be increased if the signal to noise ratio (S/N ratio) that is transmitted from the modulating/demodulating circuit 17a in the modulating transmission device 11b is below a first prescribed value, and for the transmission output to be decreased if this ratio is above a second prescribed value. In this way, the transmission output can be adjusted to a suitable magnitude. It may be arranged for these processing steps to be executed a plurality of times. In this way, the transmission output of the modulating/demodulating circuit 17b in the modulating transmission device 11a is determined.

In the above description, it was arranged for an action to be performed whereby the changeover means 23 was changed over to the transmission output adjustment means 20 with a certain timing or periodically, so that the transmission output was automatically adjusted by the transmission output adjustment means 20: however, it would also be possible for this action to be performed on power start-up or on resetting of the modulating transmission device. In the case where this action is performed on power start-up or on resetting of the modulating transmission device, the changeover means 23 is changed over to the transmission output adjustment means 20 by the power-on reset means 24.

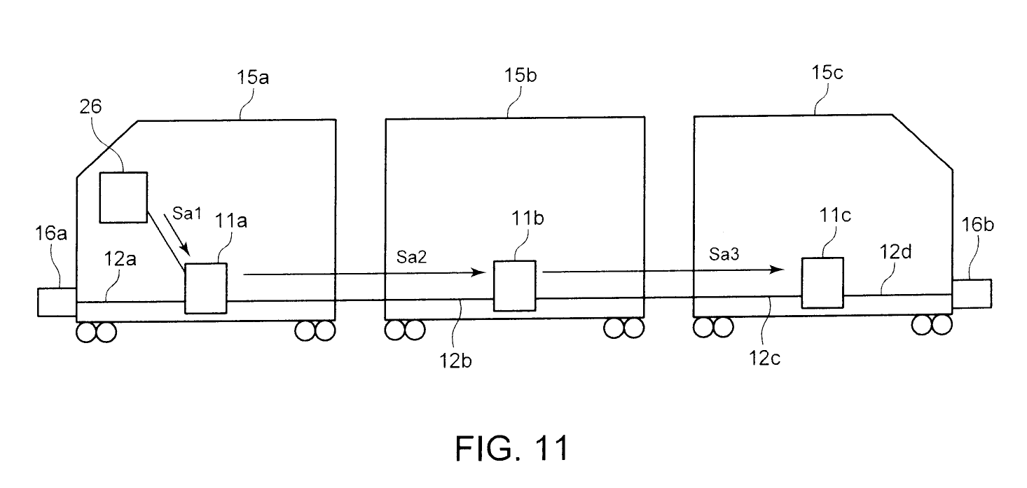

Also, it is possible to arrange for the transmission output to be automatically adjusted in response to an instruction from a display controller 26 installed in the driver's console, as shown in FIG. 11. When setting of the transmission output adjustment instruction is effected by the display controller 26, transmission output adjustment is executed by delivery of setting instruction data Sa1 to Sa3 to the respective modulating transmission devices 11a to 11c. Except in the case where the transmission output adjustment is executed by all of the modulating transmission devices 11a to 11c, this setting can also be performed individually.

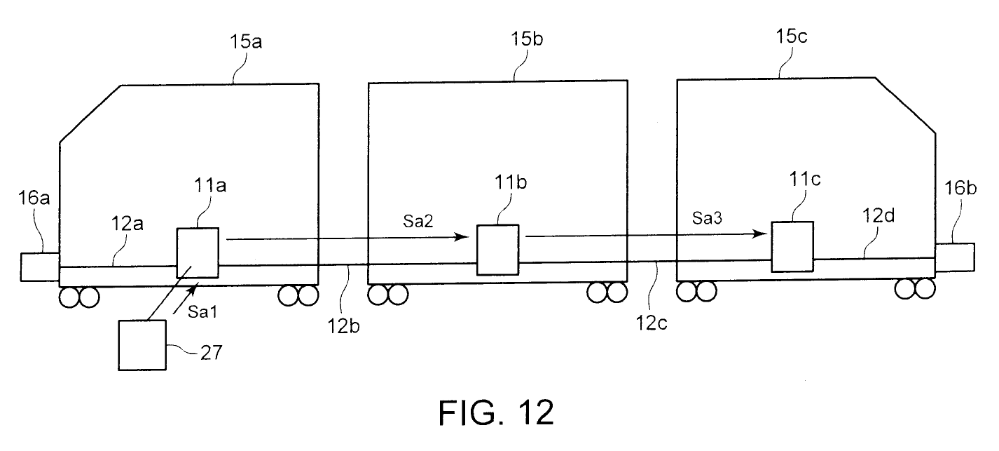

Also, as shown in FIG. 12, it is also possible to adjust the transmission output automatically by an instruction from a maintenance terminal 27 of a personal computer or the like, instead of the display controller 26 installed in the driver's console. If setting of the transmission output adjustment instruction is performed at the maintenance terminal 27 of a personal computer or the like, transmission output adjustment is executed by distributing setting instruction data Sa1 to Sa3 to the respective modulating transmission devices 11a to 11c. The action of the modulating transmission devices 11a to 11c is the same as in the case of FIG. 10. It should be noted that, instead of the output adjustment data d1 being created and transmitted by the transmission output adjustment means 20, it would also be possible for the output adjustment data d1 to be set by the maintenance terminal 27. Except in the case where the transmission output adjustment is executed by all of the modulating transmission devices 11a to 11c, this setting can also be performed individually.

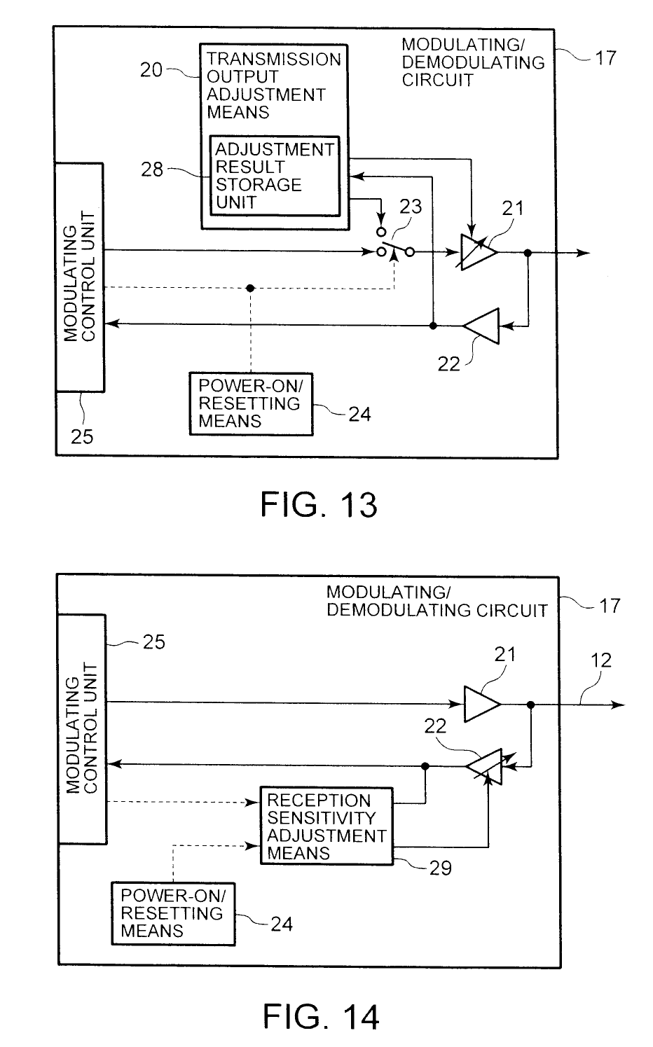

In addition, the transmission output adjustment means 20 of the modulating/demodulating circuit 17 adjusts the transmission output and, when the result of the adjustment of transmission output has been confirmed, stores this result in the adjustment result storage unit 28, as shown in FIG. 13. Specifically, when the transmission output has been adjusted, the transmission output adjustment means 20 stores this transmission output adjusted value in the adjustment result storage unit 28 and the modulating/demodulating circuit 17 of the modulating transmission device performs transmission with the stored transmission output adjustment value when the power source is restarted or when the modulating transmission device is reset. In the event of restarting of the power source or resetting of the modulating transmission device, the changeover means 23 is changed over to the transmission output adjustment means 20 by the power-on/reset means 24. It should be noted that it would also be possible to perform transmission output adjustment in accordance with the previous description after commencement of transmission with the stored transmission output adjustment value.

Although, in the above description, flow of adjustment/decision starting at the modulating transmission device 11a, from the modulating transmission device 11a in the direction of the modulating transmission device 11b was described, it would also be possible to perform adjustment/decision in the opposite direction, starting at the modulating transmission device 11b, from the modulating transmission device 11b in the direction of the modulating transmission device 11a. Also, apart from using the modulating/demodulating circuit 17a, adjustment/decision could be performed in the same way with regard to the modulating transmission device 11c, using the modulating/demodulating circuit 17b as the modulating transmission device 11b. And, when a rail vehicle of another formation is connected in parallel through an electrical coupler 16a on the left-hand side of the rail vehicle 15a, apart from using the modulating/demodulating circuit 17b as the modulating transmission device 11a, adjustment/decision could be performed in the same way using 17a.

### Second Embodiment

Next, FIG. 14 is a layout diagram showing an example of a modulating/demodulating circuit of a modulating transmission device in a second embodiment of the present invention. In this second embodiment, modulating transmission devices 11a, 11b in the case of a connection system using repeaters as shown in FIG. 8 are shown; also, the case is shown in which the preventing lowering of transmission characteristic means is reception sensitivity adjustment means 29.

In normal system operation, the modulation control unit 25 transmits signals to the transmission wire 12b through the transmission circuit unit 21; the signals from the transmission wire 12b are received by the reception circuit unit 22, and input to the modulation control unit 25 and reception sensitivity adjustment means 29. In such normal system operation, for example the modulation control unit 25 normally performs an action, by actuating the reception sensitivity adjustment means 29 with a certain timing or periodically, so as to automatically adjust the reception sensitivity by this reception sensitivity adjustment means 29. The reception sensitivity adjustment means 29 performs adjustment of reception sensitivity in accordance with the data of strength of reception. For example, adjustment of reception sensitivity is performed when the data of strength of reception departs from a predetermined prescribed range, such as to bring the strength of reception within this prescribed range.

In the above description, normally, an action was performed by the reception sensitivity adjustment means 29 to automatically adjust the reception sensitivity with a certain timing or periodically; however, it could be arranged to perform this action on power source start-up or on resetting of the modulating transmission device. If the action is performed on power source start-up or on resetting of the modulating transmission device, the reception sensitivity adjustment means 29 is actuated by a power-on reset means 24. Also, as in the first embodiment, the reception sensitivity could be automatically adjusted in response to an instruction from a display controller 26 installed in the driver's console or a maintenance terminal 27 of for example a personal computer.

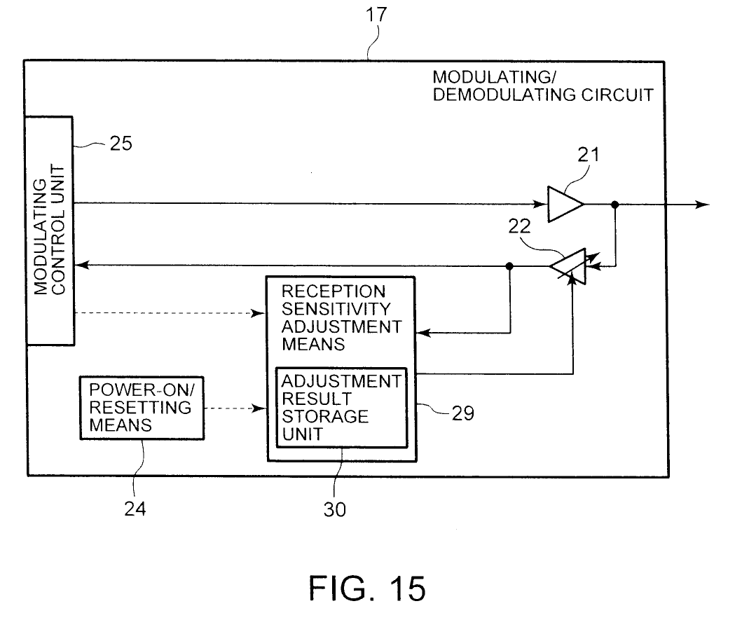

In addition, the reception sensitivity adjustment means 29 of the modulating/demodulating circuit 17 adjusts the reception sensitivity and, when the result of the adjustment of reception sensitivity has been confirmed, stores this in the adjustment result storage unit 30, as shown in FIG. 15. Specifically, when the reception sensitivity adjustment means 29 has adjusted the reception sensitivity, this adjusted reception sensitivity value is stored in the adjustment result storage unit 30 and, in the event of power source restart or resetting of the modulating transmission device, the modulating/demodulating circuit 17 performs transmission with this stored adjusted reception sensitivity value. In the event of power source restart or resetting of the modulating transmission device, the reception sensitivity adjustment means 29 is actuated by the power-on resetting means 24. It would also be possible to perform reception sensitivity adjustment in accordance with the above description after commencement of transmission with the stored adjusted reception sensitivity value.

### Third Embodiment

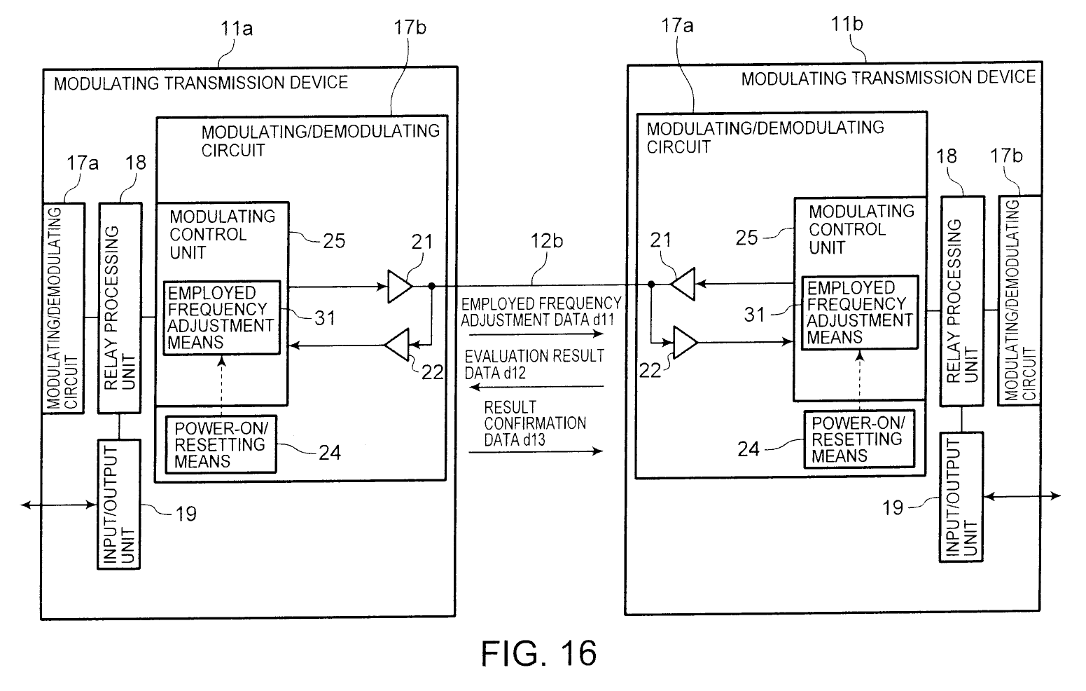

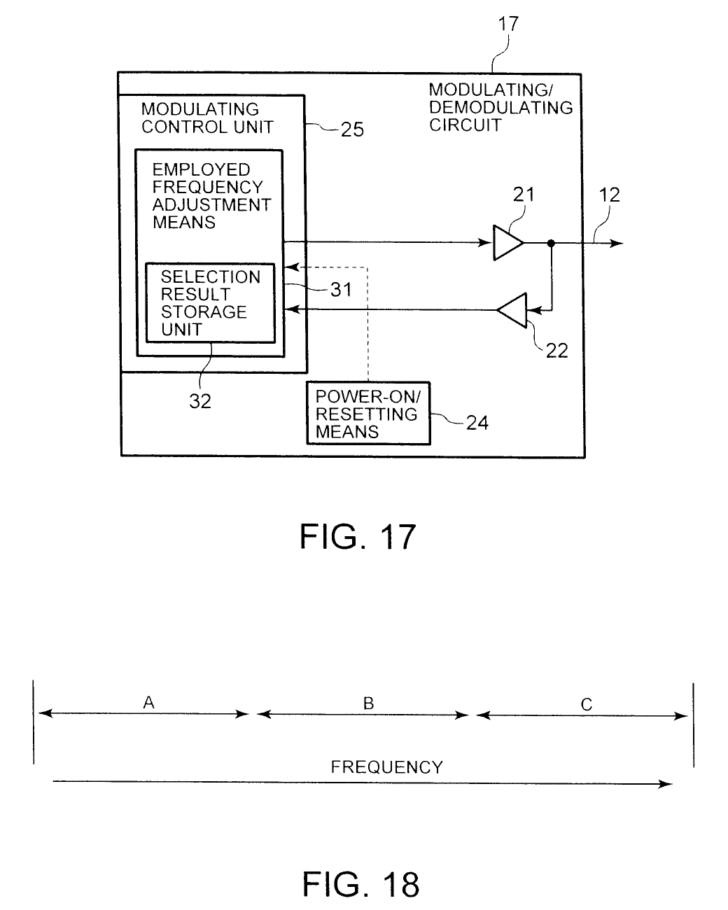

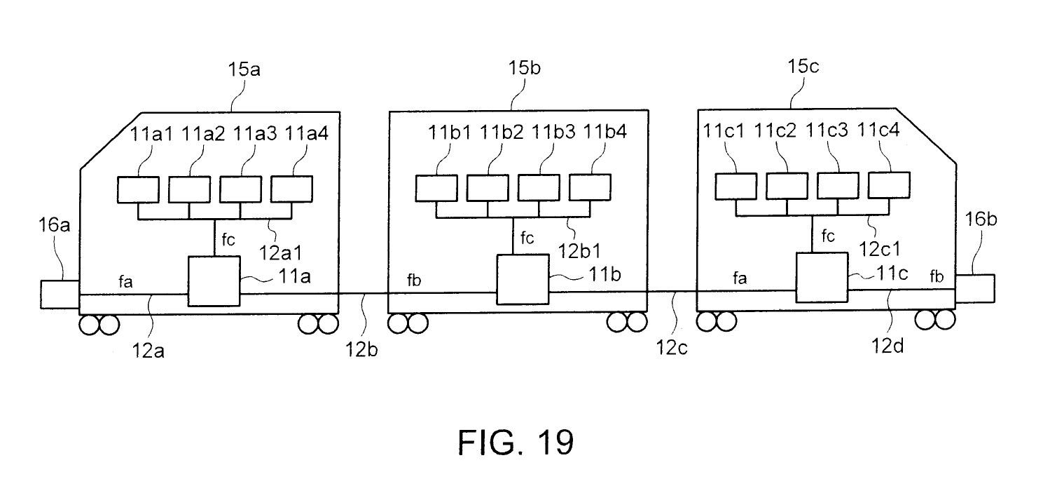

FIG. 16 is a layout diagram showing an example of a modulating transmission device 11a in a third embodiment of the present invention. In this third embodiment, modulating transmission devices 11a, 11b in the case of the repeater connection system shown in FIG. 8 are shown. Also, the case where the preventing lowering of transmission characteristic means is constituted by employed frequency adjustment means 31 is shown. The modulating transmission devices 11a, 11b exchange signals by being connected through the transmission wire 12b. The case of transmission of signals from the modulating transmission device 11a to the modulating transmission device 11b will now be described. The modulating transmission devices 11a, 11b are of the same construction, so only the modulating transmission device 11a will be described.

The modulating transmission device 11a comprises a modulating/demodulating circuit 17, a relay processing unit 18 and an input/output unit 19. The modulating/demodulating circuit 17 comprises a transmission circuit unit 21, a reception circuit unit 22, power-on/reset means 24 and a modulation control unit 25. The modulation control unit 25 comprises employed frequency adjustment means 31.

In normal system operation, the modulation control unit 25 transmits signals on the transmission wire 12b through the transmission circuit unit 21; signals from the transmission wire 12b are received by the reception circuit unit 22 and input to the modulation control unit 25. In such normal system operation, for example the modulation control unit 25 actuates the employed frequency adjustment means 31 with a certain timing or periodically and the employed frequency adjustment means 31 performs an action of automatically selecting the frequency to be employed.

The employed frequency adjustment means 31 of the modulating/demodulating circuit 17 transmits data d11 for employed frequency adjustment to the modulating/demodulating circuit 17 in the modulating transmission device 11b. When the modulating/demodulating circuit 17 in the modulating transmission device 11b receives the employed frequency adjustment data d11 it ascertains for example the frequency to noise ratio and transmits data d12 representing the result of this evaluation to the modulating/demodulating circuit 17 in the modulating transmission device 11a. The evaluation result data d12 is received by the employed frequency adjustment means 31 by means of the modulating/demodulating circuit 17 in the modulating transmission device 11a.

Once it has received the evaluation result data d12, the employed frequency adjustment means 31 transmits result confirmation data d13 to the modulating/demodulating circuit 17 in the modulating transmission device 11b, and automatically selects the frequency to be employed, in accordance with this evaluation result data d12. For example, a frequency to be employed may be automatically selected at which there is little noise. The modulating/demodulating circuit 17 in the modulating transmission device 11a thereby confirms the frequency to be used.

Although, in the above description, the employed frequency adjustment means 31 was arranged to perform an action of automatically selecting the frequency to be employed with a certain timing or periodically, it could also be arranged for this to be performed on power source start-up or on resetting of the modulating transmission device. The power-on/resetting means 24 actuates the employed frequency adjustment means 31 on power source start-up or on resetting of the modulating transmission device. Also, as in the first embodiment, it may be arranged for the frequency to be employed to be automatically selected in response to an instruction from the display controller 26 installed in the driver's console, or from the maintenance terminal 27 of a personal computer or the like.

Furthermore, when the employed frequency adjustment means 31 of the modulating/the modulating circuit 17 has selected the frequency to be employed, and the frequency to be employed as a result of the selection has been confirmed, this is stored in the selection result recording unit 32, as shown in FIG. 16. Specifically, when the employed frequency adjustment means 31 has selected the frequency to be employed, it stores this selected value of the frequency to be employed in a selection result storage unit 32, and the modulating/demodulating circuit 17, on power source restart or resetting of the modulating transmission device, performs transmission with an employed frequency of the selected frequency value that was thus stored. On power source start-up or on resetting of the modulating transmission device, the power-on resetting means 24 actuates the employed frequency adjustment means 31. It should be noted that it could be arranged to perform selection of the frequency to be employed in accordance with the foregoing description after commencement of transmission with the stored employed frequency selection value.

Next, the employed frequency adjustment means 31 may divide the frequency band into a plurality of frequency bands and may allocate an employed frequency band obtained as a result of this division process in accordance with the transmission path characteristic, so as to avoid the effects of signal interference with other networks.

### Fourth Embodiment

FIG. 18 shows an example of division into three divided frequency bands. The frequency band is divided into three zones: zone A, zone B and zone C, in accordance with the zone of the transmission wire. The frequency band is for example 2 MHz to 30 MHz. Frequency bands of respective different zones are employed for each of the zones (zone A, zone B and zone C) of the transmission wire. FIG. 16 is a layout diagram of a rail vehicle internal information network in the case where different frequency bands fa to fc are employed in each of the zones (zone A, zone B and zone C) of the transmission wire. For example, the employed frequency band of the transmission wires 12a, 12c is frequency band fa of zone A, the employed frequency band of the transmission wires 12b, 12d is frequency band fb of zone B, and the employed frequency band of the transmission wires 12a1, 12b1 and 12c1 is frequency band fc of zone C. In this way, the employed frequency bands of adjacent transmission wires 12 are frequency bands fa to fc of different zones. For example, fa=2 to 12 MHz, fb=12 to 22 MHz and fc=22 to 30 MHz.

For example, in the case of the lead rail vehicle 15a, the frequency bands of the respectively different zones represented by the transmission wires 12a, 12b and 12a1 originating from the modulating transmission device 11a are fa, fb and fc; in the case of the next rail vehicle 15b, the frequency bands of the respectively different zones represented by the transmission wires 12b, 12c and 12b1 originating from the modulating transmission device 11b are fb, fa and fc; and, likewise, in the case of the next rail vehicle 15c, the frequency bands of the respectively different zones represented by the transmission wires 12c, 12d and 12c1 originating from the modulating transmission device 11c are fa, fb and fc. In this way, the possibility of interference of the signals of the respective transmission wires 12 is eliminated.

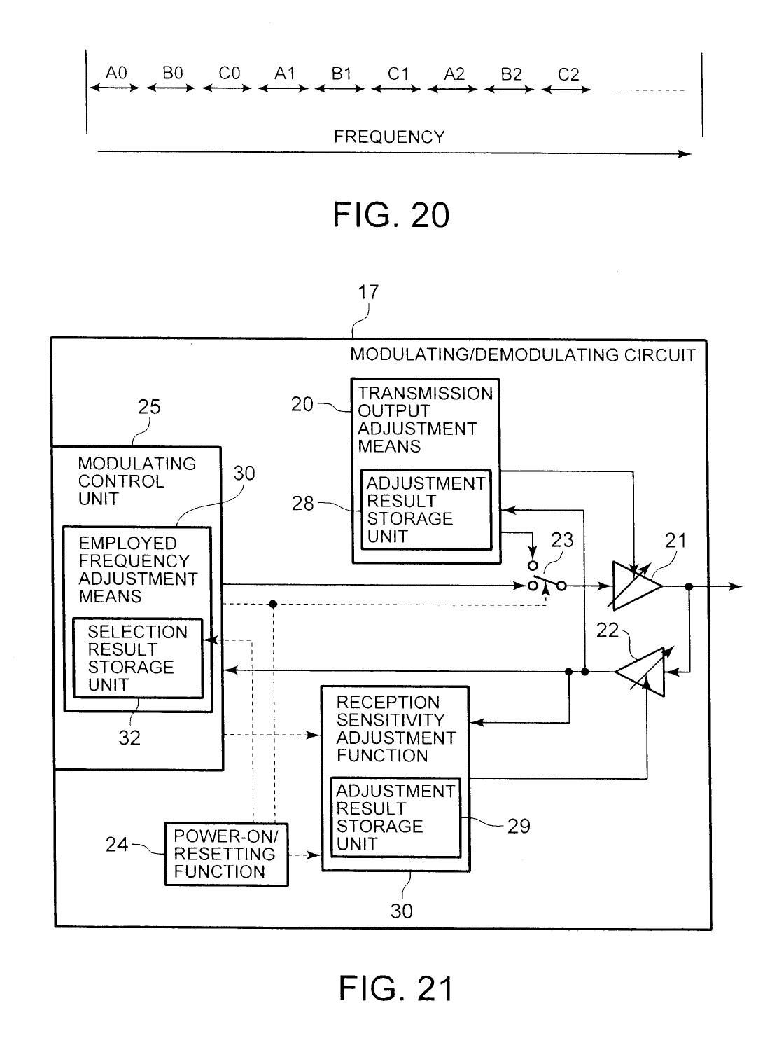

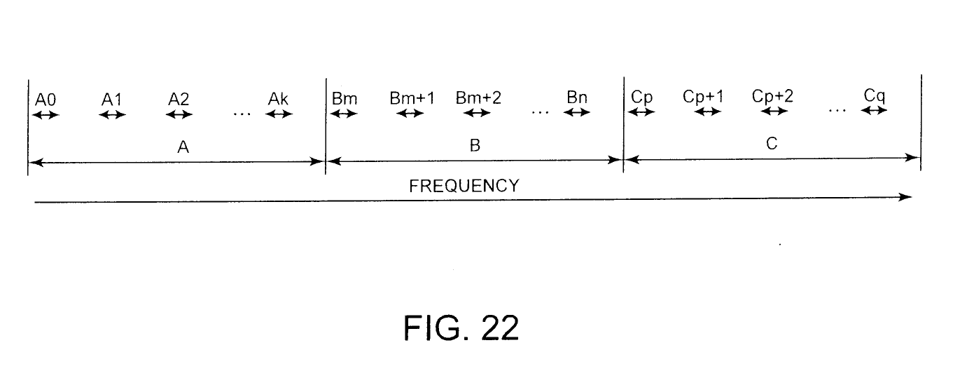

In the above description, the case where the frequency band was divided into three bands was described; however, the number of divided bands could be two, or four or more. Also, it is not necessary that the divided frequency band zones should be of equal size. Also, the frequency bands fa and fb could be continuous with each other or not, and the frequency bands fb and fc could be continuous with each other or not. Also, as shown in FIG. 20, it could be arranged for the frequency f to be further subdivided, so that frequencies fa0, fa1, fa2 . . . are employed in A0, A1 and A2 . . . in respect of the zone A; frequencies fb0, fb1, fb2 . . . are employed in B0, B1 and B2 . . . in respect of the zone B; and frequencies fc0, fc1, fc2 . . . are employed in C0, C1 and C2 . . . in respect of the zone C. In addition, as shown in FIG. 22, the frequency band division of FIG. 18 and the frequency division of FIG. 20 could be used in combination, so that frequencies fa0, fa1, fa2, . . . , fak are employed in A0, A1, A2, . . . , Ak in respect of the zone A; frequencies fbm, fbm+1, fbm+2, . . . , fbn are employed in respect of Bm, Bm+1, Bm+2, . . . , Bn of the zone B; and frequencies fcp, fcp+1, fcp+2, . . . , fcq are employed in respect of Cp, Cp+1, Cp+2, . . . , Cq of the zone C.

FIG. 21 is a layout diagram showing an example of modulating/demodulating circuit of a modulating transmission device according to a fourth embodiment of the present invention. In the first embodiment, the case is shown in which there is provided transmission output adjustment means 20; in the second embodiment, the case is shown in which there is provided reception sensitivity adjustment means 29; and in the third embodiment the case is shown in which there is provided employed frequency adjustment means 31; however, in this fourth embodiment, the case is shown in which the modulating/demodulating circuit 17 of the modulating transmission device 17 is provided with all of the following: the transmission output adjustment means 20 constituting preventing lowering of transmission characteristic means; the reception sensitivity adjustment means 29; and the employed frequency adjustment means 31. Also, a construction could be adopted provided with any two of the transmission output adjustment means 20; the reception sensitivity adjustment means 29; and the employed frequency adjustment means 31.

As described above, with this embodiment of the present invention, a high-speed information network can be constructed within a rail vehicle even without high-frequency communication transmission wires such as a coaxial cable or shielded wires, by the performance of adjustment comprising transmission output adjustment means, reception sensitivity adjustment means and employed frequency adjustment means, in order to avoid the effect of external noise or the effect of interference on the modulating transmission device. Of course, there is no objection to the use of coaxial cable or shielded wire. Also, apart from using wires, implementation using wireless is also possible.

What is claimed is:

1. A rail vehicle internal information network device comprising:
a modulating transmission device transmitting a modulated signal in accordance with characteristics of following a transmission wire and demodulating a received signal; and
a transmission wire connecting said modulating transmission device which transmits said signal to other said modulating transmission device,
wherein said modulating transmission device has a preventing lowering of transmission characteristic means for preventing lowering of transmission performance by avoiding an effect of external noise or an effect of signal interference.

2. The rail vehicle internal information network device according to claim 1,
wherein said preventing lowering of transmission characteristic means comprises at least one of:
a transmission output adjustment means for adjusting a transmission output in accordance with transmission path characteristics;
a reception sensitivity adjustment means for adjusting a reception sensitivity in accordance with said transmission path characteristics; and
an employed frequency adjustment means for adjusting an employed frequency in accordance with said transmission path characteristics or dividing a frequency into a plurality of frequencies and allocating an employed frequencies divided in accordance with said transmission path characteristics so as to be able to avoid an effect of signal interference with another network.

3. The rail vehicle internal information network device according to claim 2,
wherein said transmission output adjustment means transmits output adjustment data to said modulating transmission device at a transmission destination in response to an instruction from a display controller or a maintenance terminal installed in a driver's console on power source start-up or on resetting of a modulating transmission device, from time to time or at fixed periods during system operation, receives decision result data of said modulating transmission device at said transmission destination, and automatically adjusts a transmission output in accordance with said decision result data.

4. The rail vehicle internal information network device according to claim 3,
wherein said transmission output adjustment means, when said transmission output has been adjusted, stores an adjusted value of a transmission output and said modulating transmission device performs transmission with stored said adjust value of said transmission output on restarting of said power source or on resetting of said modulating transmission device.

5. The rail vehicle internal information network device according to claim 2,
wherein said reception sensitivity adjustment means performs adjustment of a reception sensitivity in accordance with an intensity of received data, in response to an instruction from a display controller or a maintenance terminal installed in a driver's console on power source start-up or on resetting of said modulating transmission device, from time to time or at fixed periods during system operation.

6. The rail vehicle internal information network device according to claim 5,
wherein said reception sensitivity adjustment means, when said reception sensitivity has been adjusted, stores a reception sensitivity adjustment value and said modulating transmission device performs transmission with said stored reception sensitivity adjustment value on restarting of said power source or on resetting of said modulating transmission device.

7. The rail vehicle internal information network device according to claim 2,
wherein said employed frequency adjustment means, in response to an instruction from a display controller or a maintenance terminal installed in a driver's console, on power source start-up or on resetting of a modulating transmission device, from time to time or at fixed periods during system operation, transmits employed frequency adjustment data to said modulating transmission device at said transmission destination and receives said decision result data of said modulating transmission device at said transmission destination and automatically selects an employed frequency in accordance with decision result data.

8. The rail vehicle internal information network device according to claim 2,
wherein said employed frequency adjustment means divides a frequency band into a plurality of bands and allocates divided employed frequency bands to each network so as to be able to avoid an effect of signal interference with other networks.

9. The rail vehicle internal information network device according to claim 7 or 8,
wherein said employed frequency adjustment means, when said employed frequency has been selected, stores a selected value of an employed frequency and, when divided employed frequencies have been allocated, stores divided selected values of employed frequency, and
said modulating transmission device performs transmission using stored said selected value of employed frequency on restarting of said power source or on resetting of said modulating transmission device.
